(19) United States
(12) Patent Application Publication
(10) Pub. No.: US 2006/0207645 A1
(43) Pub. Date: Sep. 21, 2006

(54) Method of manufacturing a solor cell module

(75) Inventor: Takehito Wada, Kanagawa (JP)

Correspondence Address: KANESAKA BERNER AND PARTNERS LLP, SUITE 300, 1700 DIAGONAL RD, ALEXANDRIA, VA, 22314-2848, US

(73) Assignee: FUJI ELECTRIC HOLDINGS CO., LTD., Kawasaki-shi (JP)

(21) Appl. No.: 11/373,090

(22) Filed: Mar. 13, 2006

(30) Foreign Application Priority Data
Mar. 16, 2005 (JP) 2005-075531

(51) Int. Cl. H02N 6/00

(52) U.S. Cl. 136/244

(57) ABSTRACT

A method of manufacturing a solar cell module with a plurality of solar cell submodules includes temporarily fixing an adhesive resin layer on the power generation layer of a solar cell to protect the power generation layer. The solar cell is then divided into the plurality of solar cell submodules. The adjacent solar cells are connected by lead-out electrodes with connection wiring. Another layer of adhesive resin is provided only on a surface opposite to the power generation layer of the solar cell submodules and, together with the adhesive resin on the surface of the power generation layer, melts and adheres to a protective member or a support member. The method reduces both the materials and effort required for production, and decreases manufacturing costs, while preventing poor adhesion of wiring material and surface material.

### CROSS-REFERENCE TO RELATED APPLICATION

This application is based on, and claims priority to, Japanese Patent Application No. 2005-075531, filed on Mar. 16, 2005, the contents of which are incorporated herein by reference.

### BACKGROUND OF THE INVENTION AND RELATED ART STATEMENT

The present invention relates to a method of manufacturing a solar cell module composed of a plurality of solar cell submodules, and in particular, to a method of manufacturing a solar cell module composed of a plurality of the solar cell submodules that are formed by dividing a solar cell disposed on a lengthy flexible substrate.

Solar cells have recently drawn attention as a sustainable energy source. For the solar cells to find more widespread application, it is essential to reduce manufacturing costs and prices. So, thin film solar cells produced by roll-to-roll production are expected to be low in cost and useful, in which the solar cell is produced while transporting a flexible substrate.

In manufacturing a solar cell module composed of a plurality of solar cell submodules that are formed by dividing a solar cell and then connected with one another, it has been proposed to enhance the performance and provide for protection of the solar cell. (See for example, Japanese Unexamined Patent Application Publication No. 2000-349308.) In the method disclosed in the aforementioned prior art reference, a sheet of adhesive resin is temporarily fixed on a power generation layer of the solar cell to protect the solar cell and prevent degradation of performance due to damage, breakage, or contamination. Then, the solar cell submodules are connected by connecting lead-out electrodes on the surface opposite to the power generation layer with connection members. Adhesive resin, protective member and a support member are provided on both surfaces, followed by heating and adhesion.

In the aforementioned conventional method of manufacturing a solar cell module, after connecting the lead-out electrodes of the solar cell submodules with connection members, adhesive resin is provided again on the whole surface of the power generation layer side of the solar cell submodule in order to make the surface protective member adhere to the portion of the connection member without contact to the solar cell submodule. This increases the number of sheets required in the manufacturing process, adds the cost of molding of the resin, and requires additional effort for production.

### SUMMARY OF THE INVENTION

The present invention has been developed in view of the above-described problems associated with prior art methods. An object of the invention, therefore, is to provide a method of manufacturing a solar cell module that reduces both the materials and effort necessary for production, and decreases manufacturing costs, while preventing poor adhesion between connection members and surface material which functions as protection material.

To solve the above-described problems, the present invention provides a method of manufacturing a solar cell module having a plurality of solar cell submodules. The submodules are formed by dividing a solar cell having power generation layers on one surface of a lengthy flexible substrate and lead-out electrodes on the other surface.

The manufacturing method comprises a step of preparatory fixing adhesive resin on photoelectric conversion elements of a solar cell; a step of dividing the solar cell into the plurality of solar cell submodules; a step of making connection between the lead-out electrodes of the solar cell submodules; and a step of providing adhesive resin on a surface opposite to the photoelectric conversion elements of the solar cell submodules, and allowing this adhesive resin and the adhesive resin on the photoelectric conversion elements to melt and adhere to a back surface material which functions as a reinforcing material.

This method of manufacturing a solar cell module, in which the adhesive resin is provided on the surface opposite to the photoelectric conversion elements after connecting adjacent solar cell submodules, has the following merits. The method reduces both the materials and effort required for production, and thus decreases manufacturing costs. The method also prevents poor adhesion of connection members and a back surface material, thereby providing a more reliable solar cell module.

### BRIEF DESCRIPTION OF THE DRAWINGS

FIGS. 1(A)-1(C) illustrate a laminated structure of a solar cell module according to one embodiment of the present invention;

FIG. 2 is a plan view of an overall structure of a solar cell module according to an embodiment of the invention;

FIG. 3 illustrates a cross-sectional structure in a solar cell submodule according to an embodiment of the invention; and

FIG. 4 illustrates a manufacturing procedure of a solar cell module according to an embodiment of the invention.

### DETAILED DESCRIPTION OF THE PREFERRED EMBODIMENTS

The following describes some preferred embodiments according to the invention with reference to the accompanying drawings.

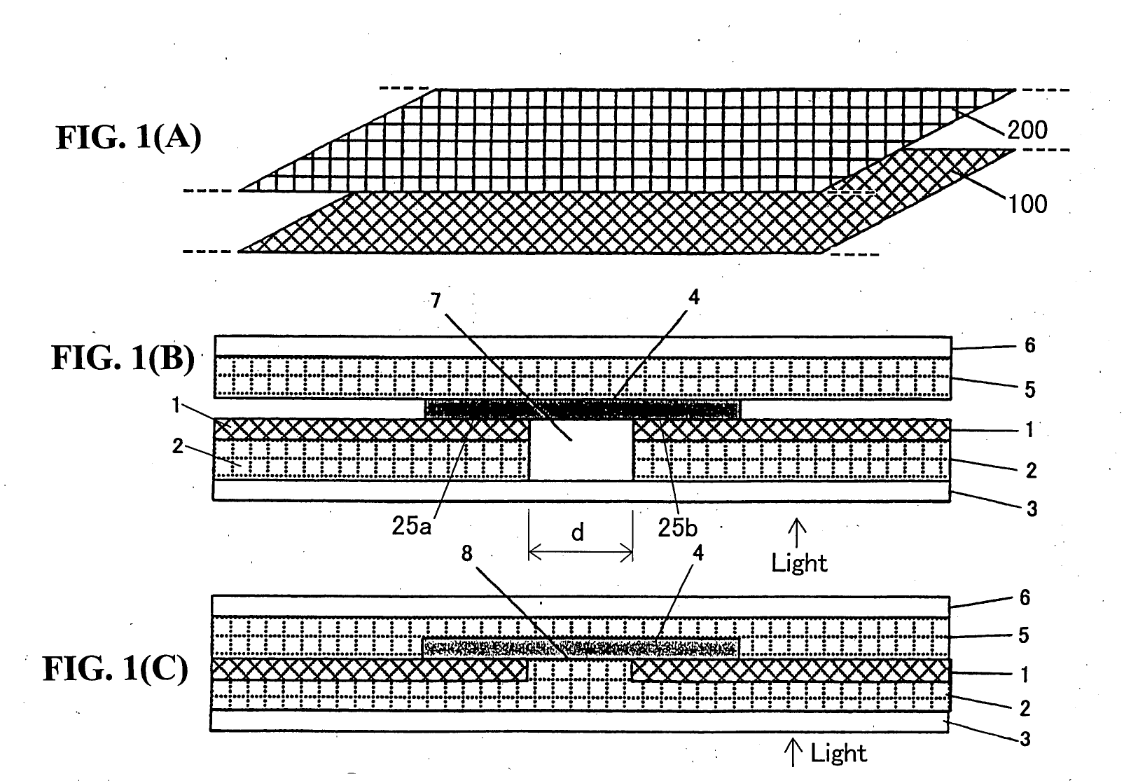

FIGS. 1(A)-1(C) illustrate a laminated structure of a solar cell module according to an embodiment of the present invention. About a solar cell 100 comprising a lengthy flexible substrate and photoelectric conversion elements formed on the substrate, as shown in FIG. 1(A), an adhesive resin sheet 200 such as EVA (ethylene vinyl acetate) is attached to the surface side of the photoelectric conversion elements of a solar cell 100 comprising a lengthy substrate and the photoelectric conversion elements formed on the substrate, to protect the power generation layers.

Subsequently, the solar cell 100 with the adhesive resin 2 is divided to form a plurality of solar cell submodules. After that process, as shown in FIG. 1(B), a surface material 3 composed of an ETFE (ethylene tetrafluoroethylene) film which functions as protection material, a fluorine-containing film exhibiting high durability against light, is disposed on the plane of incident light of the solar cell submodules 1 having the adhesive resin 2. Then, a connection member 4 composed of a conductive tape with an adhesive substance is adhered to a region of lead-out electrodes of the surface opposite to the plane of incident light, to connect the connection electrodes of the solar cell submodules. On this article, adhesive resin 5 of an EVA sheet, which is an adhesive film, is provided. Finally, a back surface material 6 of ETFE is disposed.

Adhesion of the thus laminated materials is carried out by melting the adhesive resins 2 and 5 in a heating and vacuum lamination process. While a space 7 free of resin exists between the connection member 4 and the front surface material 3 before melting, after the adhesive resins 2 and 5 are melted and compressed in the lamination process, the space 7 is filled with the adhesive resins 2 and 5 and the whole members are adhered to a monolithic body as shown in FIG. 1(C). The numeral 8 indicates the disappeared space (i.e., the space eliminated by having been filled in).

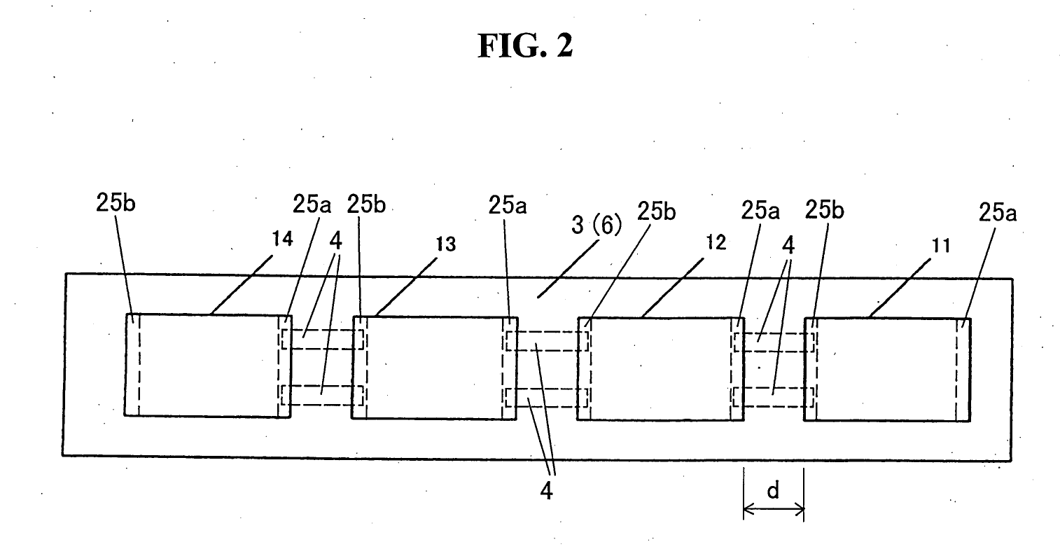

FIG. 2 is a plan view of an overall structure of a solar cell module according to the aforementioned embodiment of the invention. The solar cell module includes a plurality (four in this example) of solar cell submodules 11, 12, 13, and 14 formed on a back surface material 6. Lead-out electrodes 25a, 25b of these solar cell submodules are connected in series through connection members 4. The solar cell submodules are viewable because the front surface material 3 is transparent in this figure.

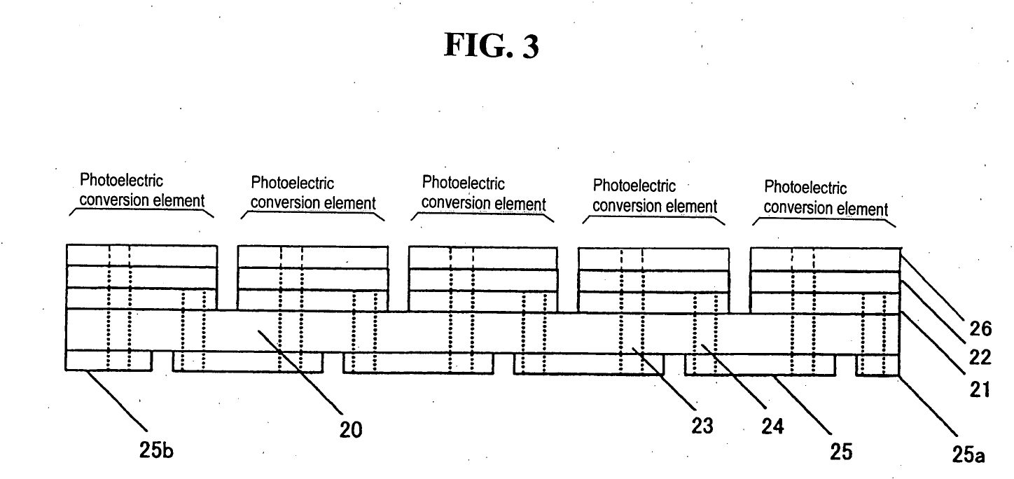

FIG. 3 illustrates a cross-sectional structure in the embodiment of the solar cell submodules 11, 12, 13, and 14 depicted in FIG. 2. This structure is common in the solar cell submodules 11, 12, 13 and 14.

As shown in FIG. 3, a bottom electrode 21, a transparent electrode 26, and a power generation layer 22 are provided on one surface of a flexible substrate 20. A plurality of photoelectric conversion elements is connected in series by through-holes 23 and 24 and a back electrode 25 provided on the surface of the flexible substrate opposite to the power generation layer 22. The connection electrodes at the both ends constitute lead-out electrodes 25a and 25b.

The solar cell submodule of this laminated structure can have a tandem structure consisting of amorphous silicon (a-Si) and amorphous silicon germanium (a-SiGe), and the flexible substrate 20 can be made from a polyimide. The flexible substrate 20 can also be a film of a resin selected from PET, PEN, polyamide, polyamideimide, polycarbonate, PBT, PPS, liquid crystalline polymer, and PEI, or a stainless steel substrate. The power generation layer 22, which is a semiconductor layer, can also be composed of amorphous silicon carbide (a-SiC), microcrystalline silicon (μ-Si), μ-SiGe, μ-SiC, or μ-Ge. In addition, the solar cell can be composed of a photoelectric conversion element of single structure or three layer tandem structure, or further, a compound solar cell, a dye-sensitized solar cell, or an organic solar cell.

The adhesive resins 2 and 5 shown in FIG. 1 enable the protective members (the front surface material 3 and the back surface material 6) to adhere to the solar cell sub modules. The adhesive resin must be stable against heat and moisture. Consequently, transparency, as well as stability, to light is needed for the adhesive resins 2 and 5 when the adhesive resins is disposed on the plane of incident light of the photoelectric conversion elements. The adhesive resin further needs to be worked in a short time, and to trace the shapes of the protective member and the solar cell. In some cases, the adhesive resin is expected to absorb external force and avoid damage. Therefore, a thermoplastic resin is employed for the adhesive resin.

Specifically, ethylene vinyl acetate copolymer (EVA) was used in the embodiment described. The material of the adhesive resin can also be selected from polyvinyl butyral, silicone resin, ethylene-acrylate copolymer resin, ethylene methacrylic acid copolymer, acrylic resin, polyethylene, polypropylene, and the like. The adhesive resin is used in the shape of a sheet because it is used in a roll-to-roll process. The sheet that is used for the roll-to-roll process has a thickness of 0.4 mm and a length of 300 m. Adhesion is carried out by melting the EVA using a roll heater at 120° C. and pressing the EVA to the photoelectric conversion elements side of the solar cell submodules aligned.

The thickness of the EVA may not be 0.4 mm, but may be any value in the range of about 0.1 mm to 2 mm. The shape of the adhesive resin is not necessarily that of a sheet, but extrusion can be employed to carry out sheet molding and adhesion simultaneously.

While an EVA sheet has been described as the adhesive film of the back surface side, the adhesive film can instead be made from other resins. Moreover, the adhesive film is not necessarily composed of a single resin, but rather may be a plural layer type, or may use a fluororesin film or woven or not-woven fabric of glass inserted in the adhesive films.

For the material of the light incident side, while an ETFE film has been described in the embodiment, the material can be a film of PTFE, FEP, PFA, PVDF, or PVF, or further, a silicone resin. Glass or another transparent resin can also be used.

For the material of the reversed side to the light incident side, while an ETFE film has been described in the embodiment, the material can be one of the materials described above, and further, can be selected from a tile, an aluminum plate, concrete, a pre-coated steel sheet, and glass plate.

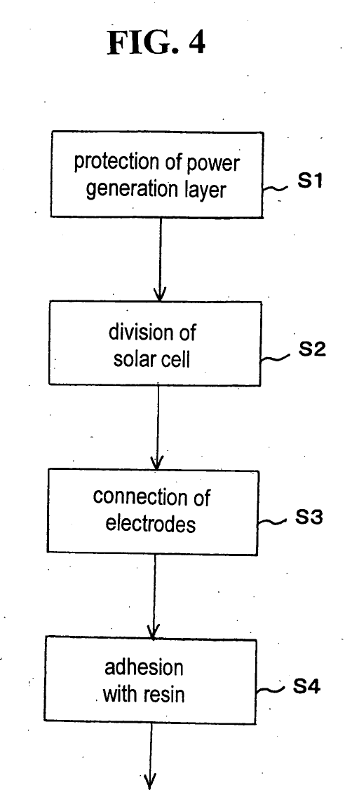

FIG. 4 illustrates a manufacturing procedure of a solar cell module according to an embodiment of the invention. This embodiment is a method of manufacturing a solar cell module comprising a plurality of solar cell submodules that are formed by dividing a solar cell having power generation layers on one surface of a continuous flexible substrate and connection members on the other surface. The method comprises the following steps.
(1) A step of temporarily fixing adhesive resin on the photoelectric conversion elements of the solar cell (Si);
(2) A step of dividing the solar cell into the plurality of solar cell submodules (S2);
(3) A step of making connection between the lead-out electrodes of the solar cell submodules (S3); and
(4) A step of providing adhesive resin on a surface opposite to the photoelectric conversion elements of the solar cell submodules, and melting and allowing this adhesive resin and the adhesive resin on the power generation layers to adhere to a protective member or a support member (S4).

In this method, after the adhesive resin is preparatory fixed on the photoelectric conversion elements of the solar cell having the power generation layers formed on one surface of a lengthy flexible substrate, the solar cell is divided into solar cell submodules. Then, the adjacent solar cell submodules are connected by connecting lead-out electrodes of the solar cells with connection members. After that, adhesive resin is provided on the surface opposite to the power generation layers of the solar cell submodules. This adhesive resin, together with the adhesive resin on the side of the power generation layers, is melted and adhered to the protective member or the support member.

Because the adhesive resin is provided only on the surface side opposite to the power generation layers after connecting adjacent solar cell submodules, the materials and effort required for manufacturing can be decreased, and thus the manufacturing costs can be reduced. The method also prevents poor adhesion of the connection members and the surface material.

The following describes certain specific examples of the method of manufacturing a solar cell module.

### EXAMPLE 1

A substrate for solar cells used in this example was an opaque polyimide substrate 50 μm thick. EVA 0.4 mm thick and ETFE 25 μm thick were used on the light incident side. The conductive tape for the connection member was 8 mm wide. In the surface side opposite to the light incident side, EVA 0.4 mm thick and ETFE 0.8 mm thick were used.

A vacuum lamination process was carried out through the following profile.

Process (1) evacuation: temperature 80° C., pressure 0 atm, duration 5 min;

Process (2) pressing: temperature 120° C., pressure 1 atm, duration 10 min;

Process (3) curing: temperature 150° C., pressure 1 atm, duration 20 min.

Table 1 shows the distance between the divided solar cell submodules and the existence of a clearance lacking adhesive resin on the conductive tapes which are the connection members (void spaces which may cause defects). It is understood that the resins well adhere to the conductive tapes in the range that the distance d is equal to or less than 2.5 mm.

TABLE 1

| | | | | | | |
|---|---|---|---|---|---|---|
| distance (mm) | 1 | 2 | 2.5 | 3 | 3.5 | 4 |
| clearance | None | none | None | existing | existing | existing |

### EXAMPLE 2

A solar cell module was manufactured in a manner similar to that of Example 1 except that the thickness of the EVA on the light incident side was 0.8 mm.

Table 2 shows the distance between the divided solar cell submodules and the existence of a clearance lacking adhesive resin on the conductive tapes which are the connection members (void spaces which may cause defects). It is understood that the resins well adhere to the conductive tapes in the range that the distance d is equal to or less than 4 mm.

TABLE 2

| | | | | |
|---|---|---|---|---|
| distance (mm) | 2 | 3 | 4 | 5 |
| clearance | none | none | None | existing |

As shown in Tables 1 and 2, the distance between the adjacent solar cell submodules is preferably about five times or less than the thickness of the adhesive resin on the side of the power generation layers.

While the invention has been explained with reference to the specific embodiments of the invention, the explanation is illustrative and the invention is limited only by the appended claims.

What is claimed is:

1. A method of manufacturing a solar cell module having a plurality of solar cell submodules, the method comprising the steps of:
temporarily fixing, on a solar cell having a power generation layer on one surface of a lengthy flexible substrate and lead-out electrodes on the other surface, a first adhesive resin layer on the power generation layer surface;
dividing the temporarily fixed first adhesive resin layer and solar cell into the plurality of solar cell submodules;
connecting the lead-out electrodes of the plurality of solar cell submodules;
temporarily fixing a second adhesive resin layer on a surface opposite to the power generation layer of the plurality of solar cell submodules; and
enabling the first adhesive resin layer and the second adhesive resin layer to provide adhesion for the solar cell module.

2. The method of manufacturing a solar cell module according to claim 1, wherein a distance between adjacent solar cell submodules is approximately less than or equal to five times a thickness of the first adhesive resin layer.

3. The method of manufacturing a solar cell module according to claim 1, wherein the step of enabling the first adhesive resin layer and the second adhesive resin layer to provide adhesion for the solar cell module comprises melting and curing the resin layers.

4. The method of manufacturing a solar cell module according to claim 1, wherein the first adhesive resin layer and the second adhesive resin layer are a same resin material.

5. The method of manufacturing a solar cell module according to claim 1, wherein the step of connecting the lead-out electrodes of the plurality of solar cell submodules employs a conductive tape with an adhesive surface.

6. The method of manufacturing a solar cell module according to claim 1, further comprising the steps of
applying a first protective layer to the temporarily fixed first adhesive resin layer; and
applying a second protective layer to the temporarily fixed second adhesive resin layer.

7. The method of manufacturing a solar cell module according to claim 6, wherein the first adhesive resin layer and the second adhesive resin layer provide adhesion for the applied first and second protective layers.

8. The method of manufacturing a solar cell module according to claim 7, further comprising the step of
applying a vacuum force between the first and second protective layers to reduce spaces therebetween and connect the adhesives.
